(19) United States
(12) Patent Application Publication
(10) Pub. No.: US 2022/0364505 A1
(43) Pub. Date: Nov. 17, 2022

(54) RENEWABLE FUEL POWER SYSTEMS FOR VEHICULAR APPLICATIONS

(71) Applicant: AMOGY Inc., Brooklyn, NY (US)

(72) Inventors: Hyunho Kim, Brooklyn, NY (US); Young Suk Jo, Brooklyn, NY (US)

(21) Appl. No.: 17/366,633

(22) Filed: Jul. 2, 2021

Related U.S. Application Data
(60) Provisional application No. 63/188,593, filed on May 14, 2021.
(60) Provisional application No. 63/209,530, filed on Jun. 11, 2021.

(51) Int. Cl. F02C 3/30; B64D 37/04; B64D 27/16; B64D 27/24; B64D 41/00; B64D 37/30; B64D 37/34; F02C 7/22; F02C 7/14

(52) U.S. Cl. CPC F02C 3/30; B64D 37/04; B64D 27/16; B64D 27/24; B64D 41/00; B64D 37/30; B64D 37/34; F02C 7/22; F02C 7/14; B64D 2041/005; F05D 2220/323

(57) ABSTRACT

Renewable fuel power systems for vehicles, such as aircraft, are provided. For example, a system includes a storage tank, a reactor module, a heat exchanger unit, and a combustion engine. The storage tank is configured to store ammonia in liquid form. The reactor module is in fluid communication with the storage tank. The reactor module is configured to extract hydrogen from the ammonia, and output fuel which includes the extracted hydrogen. The heat exchanger unit is configured to heat the ammonia which flows from the storage tank to an input of the reactor module, using heat which is extracted from the fuel that is output from the reactor module. The combustion engine is configured to combust the fuel provided by the reactor module, to thereby produce mechanical power.

### CROSS-REFERENCE TO RELATED APPLICATIONS

This application claims priority to U.S. Provisional Application Ser. No. 63/188,593, filed on May 14, 2021, and to U.S. Provisional Application Ser. No. 63/209,530, filed on Jun. 11, 2021, the disclosures of which are fully incorporated herein by reference.

### BACKGROUND

There are concerted efforts to reduce greenhouse-gas emissions and protect against climate change. Such efforts currently include continuing research and development with regard to renewable energy sources for electrical power generation systems and fuel power systems for operating vehicles and, in particular, the generation and utilization of carbon-neutral and carbon-free fuels produced from renewable sources. One promising technology for renewable energy involves the use of ammonia as a green fuel and a hydrogen fuel source. However, as with all potential renewable energy sources, the effective utilization of a given renewable energy source is not trivial, since the pathway for effectively utilizing a renewable energy source must take into consideration critical aspects of such use. For example, such considerations include, but are not limited to, the ability to mass produce the renewable energy resource (without adversely affecting the environment through such production), the ability to safely and efficiently store the renewable energy resource, the ability to efficiently and effectively generate the power that is needed for a given application (e.g., vehicular application) using the renewable energy source, etc.

### SUMMARY

Exemplary embodiments of the disclosure include renewable fuel power systems for vehicles. For example, in one exemplary embodiment, a system comprises a storage tank, a reactor module, a heat exchanger unit, and a combustion engine. The storage tank is configured to store ammonia in liquid form. The reactor module is in fluid communication with the storage tank. The reactor module is configured to extract hydrogen from the ammonia, and output fuel which comprises the extracted hydrogen. The heat exchanger unit is configured to heat the ammonia which flows from the storage tank to an input of the reactor module, using heat which is extracted from the fuel that is output from the reactor module. The combustion engine is coupled to an output of the reactor module. The combustion engine is configured to combust the fuel provided by the reactor module, to thereby produce mechanical power.

Another exemplary embodiment includes an aircraft which comprises a storage tank, a reactor module, a heat exchanger unit, and a combustion engine. The storage tank is configured to store ammonia in liquid form. The reactor module is in fluid communication with the storage tank. The reactor module is configured to extract hydrogen from the ammonia, and output fuel which comprises the extracted hydrogen. The heat exchanger unit is configured to heat the ammonia which flows from the storage tank to an input of the reactor module, using heat which is extracted from the fuel that is output from the reactor module. The combustion engine is coupled to an output of the reactor module. The combustion engine is configured to combust the fuel provided by the reactor module, to thereby produce mechanical power.

Another exemplary embodiment includes an aircraft which comprises a storage tank, a reactor module, a heat exchanger unit, a fuel cell, and an electric engine. The storage tank is configured to store ammonia in liquid form. The reactor module is in fluid communication with the storage tank. The reactor module is configured to extract hydrogen from the ammonia, and output fuel which comprises the extracted hydrogen. The heat exchanger unit configured to heat the ammonia which flows from the storage tank to an input of the reactor module, using heat which is extracted from the fuel that is output from the reactor module. The fuel cell is coupled to an output of the reactor module. The fuel cell is configured to convert the fuel provided by the reactor module into electrical power. The electric engine is coupled to an output of the fuel cell. The electric engine is configured to convert the electrical power into mechanical power.

Other embodiments will be described in the following detailed description of exemplary embodiments, which is to be read in conjunction with the accompanying figures.

### BRIEF DESCRIPTION OF THE DRAWINGS

FIG. 1 schematically illustrates a renewable fuel power system for a combustion engine vehicle, according to an exemplary embodiment of the disclosure.

FIG. 2 schematically illustrates a renewable fuel power system for a combustion engine vehicle, according to another exemplary embodiment of the disclosure.

FIG. 3 schematically illustrates a renewable fuel power system for an electric engine vehicle, according to an exemplary embodiment of the disclosure.

FIGS. 4A and 4B schematically illustrate a configuration for implementing a renewable fuel power system for an aircraft which is powered by a combustion engine, according to an exemplary embodiment of the disclosure.

FIGS. 5A and 5B schematically illustrate a configuration for implementing a renewable fuel power system for an aircraft which is powered by a combustion engine, according to another exemplary embodiment of the disclosure.

FIGS. 6A and 6B schematically illustrate a configuration for implementing a renewable fuel power system for an aircraft which is powered by a combustion engine, according to another exemplary embodiment of the disclosure.

FIGS. 7A and 7B schematically illustrate a configuration for implementing a renewable fuel power system for an aircraft which is powered by a combustion engine, according to another exemplary embodiment of the disclosure.

FIGS. 8A and 8B schematically illustrate a configuration for implementing a renewable fuel power system for an aircraft which is powered by an electric engine, according to an exemplary embodiment of the disclosure.

FIG. 9 schematically illustrates an exemplary architecture of a computer system which is configured to monitor and control a renewable fuel power system, according to an exemplary embodiment of the disclosure.

### DETAILED DESCRIPTION

Embodiments of the disclosure will now be described in further detail with regard to renewable fuel power systems for vehicles, such as aircraft. It is to be understood that the various features shown in the accompanying drawings are schematic illustrations that are not drawn to scale. Moreover, the same or similar reference numbers are used throughout the drawings to denote the same or similar features, elements, or structures, and thus, a detailed explanation of the same or similar features, elements, or structures will not be repeated for each of the drawings. Further, the term “exemplary” as used herein means “serving as an example, instance, or illustration”. Any embodiment or design described herein as “exemplary” is not to be construed as preferred or advantageous over other embodiments or designs.

For illustrative purposes, exemplary embodiments of the disclosure will be discussed in the context of renewable fuel power systems for vehicular applications in which liquid ammonia (NH₃) is utilized as a fuel source for vehicles with an ammonia internal combustion engine (A-ICE), as well as renewable fuel power systems for vehicular applications in which liquid ammonia is utilized as a source for producing hydrogen (H₂) fuel for vehicles with a hydrogen internal combustion engine (H-ICE), or vehicles with an electric engine that is powered by a hydrogen fuel cell. The use of ammonia as a renewable fuel, or as a source (hydrogen carrier) for producing hydrogen for vehicular application provides many advantages.

For example, ammonia can be mass produced using well known industrial processes, which do not generate undesirable byproducts that can adversely affect the environment. For example, ammonia can be mass produced with industrial systems that implement the Haber-Bosch process (an artificial nitrogen fixation process). The Haber-Bosch process (also referred to as Haber ammonia process, or synthetic ammonia process) involves directly synthesizing ammonia from hydrogen and nitrogen: 2NH₃↔N₂+3H₂. More specifically, the synthetic ammonia process involves converting atmospheric nitrogen (N₂) to ammonia (NH₃) by a reaction with hydrogen (e.g., H₂ produced or obtained by electrolysis) using a metal catalyst (e.g., iron) under suitable temperatures and pressures, while ammonia is removed from the batch as soon as it is formed to maintain an equilibrium that favors ammonia formation. Advantageously, the production of ammonia using the Haber-Bosch process can be powered by renewable energy sources (e.g., solar photovoltaic or solar-thermal), which makes the production process environmentally safe and friendly, as N₂ is the only byproduct and there is no further emission of CO₂.

Another advantage associated with using ammonia as renewable fuel or source for hydrogen fuel is that ammonia (as a hydrogen carrier) can be readily stored and transported at relatively standard conditions (0.8 MPa, 20° C. in liquid form). In addition, ammonia has a relatively high hydrogen content (17.7 wt %, 120 grams of H₂ per liter of liquid ammonia) and, thus, liquid ammonia provides a relatively high H₂ storage capacity. Compared to other fuel types such as hydrogen, ammonia exhibits a favorable volumetric density in view of its gravimetric density. Further, in comparison to other types of fuel (e.g., methane, propane, methanol, ethanol, gasoline, E-10 gasoline, JP-8 jet fuel, or diesel), the use of ammonia as a fuel does not produce harmful emissions such as NOₓ or CO₂. Thus, the use of ammonia as an energy carrier allows the exemplary vehicular fuel power systems as disclosed herein to leverage the benefits of ammonia and/or hydrogen fuel (e.g., environmentally safe and high gravimetric energy density) once the ammonia is broken down into hydrogen, while taking advantage of (1) ammonia's greater volumetric density compared to hydrogen and (ii) the ability to transport ammonia at standard temperatures and pressures without requiring complex and highly pressurized storage vessels like those typically used for storing and transporting hydrogen.

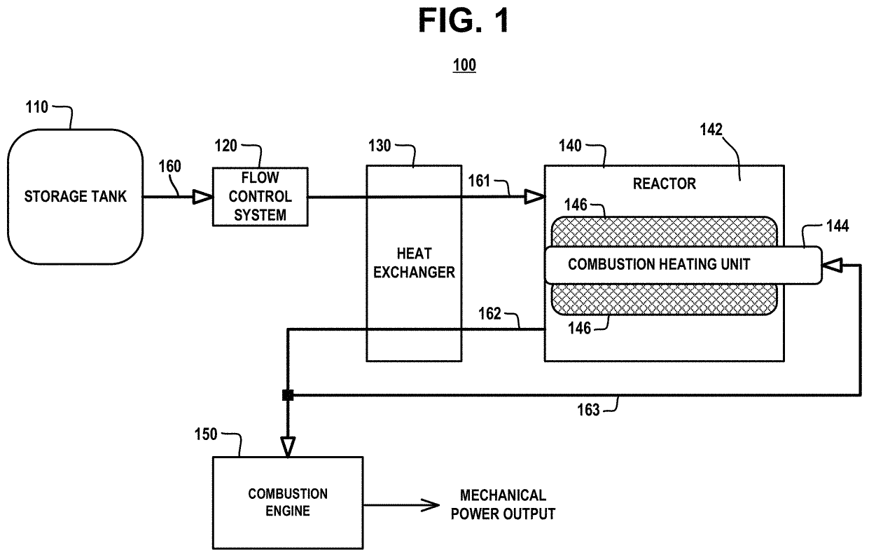

FIG. 1 schematically illustrates a renewable fuel power system 100 for a combustion engine vehicle, according to an exemplary embodiment of the disclosure. The renewable fuel power system 100 comprises a storage tank 110, a flow control system 120, a heat exchanger unit 130, a reactor module 140, a combustion engine 150, and fuel lines 160, 161, 162, and 163. In some embodiments, the reactor module 140 comprises an internal chamber 142, a catalyst 146 disposed within the chamber 142, and a combustion heating unit 144 which is configured to directly heat the catalyst 146 within the chamber 142. In some embodiments, the storage tank 110, the flow control system 120, the heat exchanger unit 130, the reactor module 140, and the fuel lines 160, 161, 162, and 163 comprise a fuel delivery system which supplies fuel to the combustion engine 150. The combustion engine 150 is configured to combust the fuel provided by the reactor module 140, to thereby produce mechanical power. It is to be understood that FIG. 1 schematically illustrates salient components of the fuel delivery system, and that the fuel delivery system would have other components, such as sensors and controllers to monitor and control the fuel generation and delivery of fuel to the combustion engine 150, depending on the type of combustion engine and the type of vehicle in which the renewable fuel power system 100 is implemented.

The storage tank 110 is configured to store a hydrogen source material in liquid form. In some embodiments, the hydrogen source material comprises liquid ammonia. As noted above, the properties of ammonia make it suitable as a carbon-free alternative fuel for power generation (e.g., ammonia is a combustible gas with a relatively high gravimetric energy density (12.7 MJ/L) and can be produced on a large-scale and easily stored in liquid form). The reactor module 140 is in fluid communication with the storage tank 110 through the fuel lines 160 and 161 and the flow control system 120. The flow control system 120 is configured to control/regulate the flow of the hydrogen source material (e.g., ammonia) from the storage tank 110 to the reactor module 140.

In some embodiments, the reactor module 140 (e.g., ammonia dehydrogenation reactor) comprises an ammonia reforming system which is configured to produce hydrogen by reforming ammonia which flows into the internal chamber 142 of the reactor module 140 via the fuel line 161. The catalyst 146 is configured to provide a catalytic reaction to cause the decomposition of ammonia into hydrogen, when the catalyst 146 is heated to a target temperature by the combustion heating unit 144 and exposed to the ammonia within the internal chamber 142. The reactor module 140 outputs fuel (which results from the reforming of ammonia) to the fuel line 162, which delivers the fuel to the combustion engine 150.

The reactor module 140 can be configured to provide a maximum target hydrogen conversion rate from ammonia to hydrogen, depending on the engine-type of the combustion engine 150. For example, in some embodiments, the combustion engine 150 comprises a hydrogen internal combustion engine, while in other embodiments, the combustion engine 150 comprises an ammonia internal combustion engine. In embodiments where the combustion engine 150 is a hydrogen internal combustion engine, the ammonia reforming system of the reactor module 140 is configured to deliver hydrogen at a high rate, wherein the fuel output from the reactor module 140 comprises a relatively high concentration of hydrogen (e.g., 90% or greater) with minimal residual ammonia contamination.

On the other hand, in embodiments where the combustion engine 150 is an ammonia internal combustion engine, the ammonia reforming system of the reactor module 140 is configured to provide partial ammonia reforming, with a maximum conversion rate from NH₃ to H₂ (e.g., 25%, 50%, etc.). In this instance, the fuel output from the reactor module 140 comprises a mixture of ammonia and hydrogen. The fuel mixture of ammonia and hydrogen advantageously facilitates and enhances combustion of the fuel mixture in the ammonia internal combustion engine. In general, ammonia is known to have relatively slow “burning velocity” and “flame speed” (or “flame velocity”), wherein the “burning velocity” denotes a speed at which a flame front propagates relative to unburned gas, and wherein the “flame speed” is a measured rate of expansion of a flame front in a combustion reaction. The flame speed of a fuel is a property which determines the ability of the fuel to undergo controlled combustion without detonation. In an ammonia combustion engine, the H₂—NH₃ fuel mixture increases the burning velocity and flame speed of the fuel mixture, and thus increases the combustion rate and efficiency of the ammonia internal combustion engine, as compared to pure NH₃ fuel in the ammonia internal combustion engine.

The heat exchanger unit 130 is configured to heat the hydrogen source material which flows from the storage tank 110 to the input of the reactor module 140, using heat which is extracted from the fuel that is output from the reactor module 140. For example, as schematically shown in FIG. 1, a portion of the input fuel line 161 is disposed within the heat exchanger unit 130, and a portion of the output fuel line 162 is disposed within the heat exchanger unit 130. The liquid ammonia which is stored in the storage tank 110 can have a relatively low temperature (e.g., below 0° F.), while the fuel output from the reactor module 140 can have a relatively high temperature. The heat exchanger unit 130 is structurally configured to extract heat from the fuel flowing through the output fuel line 162 to heat the ammonia that flows from the storage tank 110 to the input of the reactor module 140. The heating of the liquid ammonia which is input to the reactor module 140 serves to enhance the ammonia reforming process that is performed by the reactor module 140, as the liquid ammonia is pre-heated to a higher temperature than the storage temperature, which increases the efficiency of the ammonia reforming process.

The heat exchanger unit 130 can be implemented using any heat exchanger system or device which is suitable for the given application of heating of the ammonia which is supplied to the input of the reactor module 140. For example, in an exemplary embodiment, the heat exchanger unit 130 can be a closed system which has an input port to receive the liquid ammonia, wherein the liquid ammonia flows through the heat exchanger unit 130 in direct contact with one or more fuel lines inside the heat exchanger unit 130 which carry the heated output fuel from the reactor module 140. In this instance, the liquid ammonia in the heat exchanger unit 130 is heated by contact with the fuel line(s), and then flows out from an output port of the heat exchanger unit 130, and is supplied to the reactor module 130 via the fuel line 161.

In some embodiments, the heat exchanger unit 130 is structurally configured as a “shell-and-tube” type heat exchanger system which comprises a shell (e.g., large pressure vessel) with a set of tubes (referred to as tube bundle) inside the shell. The heated output fuel from the reactor module 140 flows through the tube bundle, while the liquid ammonia from the storage tank 110 flows through the shell over the tube bundle to transfer heat from the output fuel to the liquid ammonia that is supplied to the reactor module 140. In other embodiments, the heat exchanger unit 130 is structurally configured as a “cross-flow” type of heat exchanger system, wherein the liquid ammonia and heated output fuel flow in perpendicular directions (cross flow). For example, in one exemplary embodiment, a cross-flow heat exchanger system can be a finned tubular heat exchange system, wherein the heated output fuel flows in tubes within a heat exchanger shell, wherein the tubes are coupled to fins, and the ammonia flows between the fins in a direction transverse to the tube flow direction. In other embodiments, the heat exchanger unit 130 can be implemented using a “plate-and-frame” type heat exchanger configuration.

In some embodiments, the combustion heating unit 144 of the reactor module 140 comprises a combustion heating unit which is configured to receive a portion of the fuel output from the reactor module, and combust the received fuel to generate heat which utilized to heat the catalyst 146. More specifically, as schematically illustrated in FIG. 1, the fuel line 163 is coupled to the output fuel line 162, and serves to feed back some of the fuel that is generated and output from the reactor module 140 into the combustion heating unit 144. The combustion heating unit 144 generates thermal energy for heating the catalyst 146 by combusting the fuel supplied by the fuel line 163. In this regard, the combustion heating unit 144 is configured to heat the catalyst 146 by combusting some of the fuel that is output from the reactor module 140. In other embodiments, the fuel source for the combustion heating unit 144 may be provided by a separate source. For example, the separate source can be a separate storage tank which stores a combustion fuel (e.g., methane) which is specifically used for operation of the combustion heating unit 144.

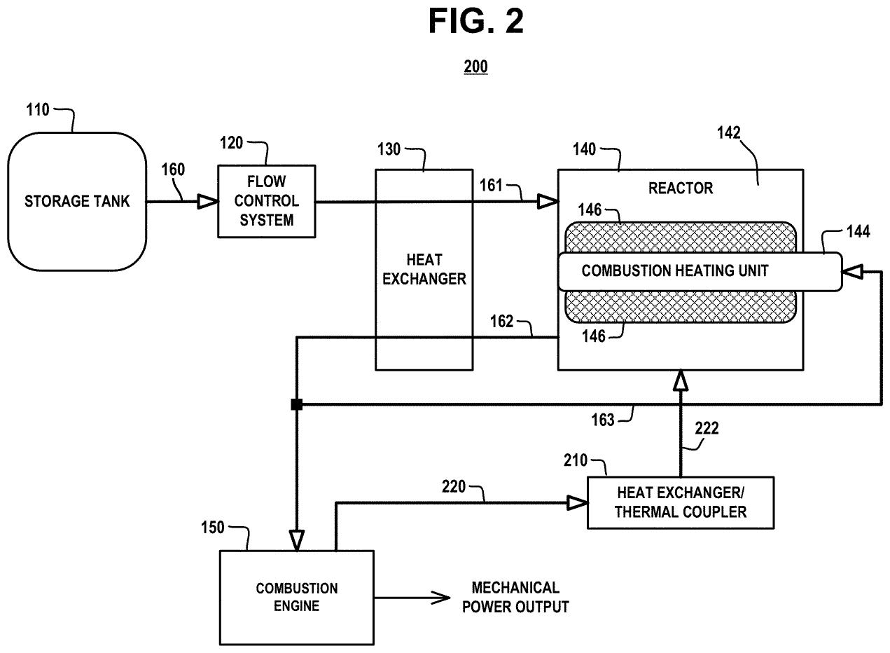

FIG. 2 schematically illustrates a renewable fuel power system 200 for a combustion engine vehicle, according to another exemplary embodiment of the disclosure. The renewable fuel power system 200 is similar to the renewable fuel power system 100 of FIG. 1, except that the renewable fuel power system 200 comprises a second heat exchanger unit 210 (e.g., exhaust gas heat exchanger unit) which is configured to heat the reactor module 140 (e.g., heat the catalyst 146) using heated combustion gas which is output from the combustion engine 150. In some embodiments, the heated combustion gas generated by the combustion engine 150 is supplied to the heat exchanger unit 210 through some suitable configuration of insulated piping/ducting 220. The reactor module 140 is in thermal communication with the heat exchanger unit 210 using a suitable structural thermal interface 222 which is configured to transfer heat from the combustion gas (flowing in the heat exchanger unit 210) to the reactor module 140.

For ease of illustration, the structural thermal interface 222 is generically depicted in FIG. 2, although it is to be understood that the thermal interface 222 but can be implemented in any manner which is suitable for the given application. For example, in some embodiments, the heat exchanger unit 210 can be a chamber or system of connected chambers, which are made from a material with high thermal conductivity (e.g., metallic material), wherein the heat exchanger unit 210 is thermally coupled to the outer casing of the reactor module 140, allowing the reactor module 140 to absorb the thermal energy of the combustion gas flowing through the heat exchanger unit 210. In other embodiments, the heat exchanger unit 210 may comprise an enclosed chamber which includes entire the reactor module 140 disposed therein, or which encloses a portion of the reactor module 140. In such embodiments, the heated combustion gas which flows through heat exchanger unit 210 directly heats the reactor module 140, or the portion of the reactor module 140, which is disposed within the heat exchanger unit 210. In other embodiments, the structural thermal interface 222 may comprise a tube or series of tubes which extend through the internal chamber 142 of the reactor module 140 and which are configured to heat the catalyst 146 using the heat from the combustion gas that flows through the tubes(s). In such embodiments, the exhaustion gas tube(s) can be in direct contact with catalyst beds within the reactor module 140.

In other embodiments, the heat exchanger unit 210 is implemented using a suitable thermal interface structure to thermally couple the reactor module 140 directly to the combustion engine 150 and allow heat generated by the combustion engine 150 to be transferred to the casing of the reactor module 140 to thereby heat the reactor module 140. In such embodiments, the reactor module 140 would be disposed in close proximity to the combustion engine 150 to enable efficient heat transfer from the combustion engine 150 to the reactor module 140 via the thermal interface. In some embodiments, the reactor module 140 can be in direct thermal contact with a portion of the combustion engine 150, or otherwise structurally integrated with the combustion engine 150.

In the exemplary embodiment of FIG. 2, the renewable fuel power system 200 is configured to utilize thermal energy generated by the combustion engine 150 to provide heat to the reactor module 140 (e.g., heat the catalyst 146) for the ammonia reforming process. The heat exchanger unit 210 is utilized in conjunction with the combustion heating unit 144 of the reactor module 140 to provide the heat for the ammonia reforming process. In some embodiments, the thermal energy generated by the combustion engine 150 can be used as a primary source of heat for the ammonia reforming process, wherein the combustion heating unit 144 is operated when the thermal energy provided by the combustion engine 150 is not sufficient to heat the catalyst 146 to the target temperature needed for the ammonia reforming process.

While the exemplary embodiment of FIG. 2 schematically illustrates the second heat exchanger unit 210 being utilized to heat the reactor module 140 using heated combustion gas which is output from the combustion engine 150, in some embodiments, the second heat exchanger unit 210 is utilized instead to heat the storage tank 110 to facilitate evaporation of the liquid hydrogen source material (e.g., ammonia) for the reforming process that is performed by the reactor module 140. In other embodiments, in addition the second heat exchanger unit 210 for heating the reactor module 140, the renewable fuel power system 200 further comprises a third heat exchanger unit (e.g., exhaust gas heat exchanger unit) which is configured to heat the storage tank 110 to facilitate the evaporation of the liquid hydrogen source material (e.g., ammonia) for the reforming process performed by the reactor module 140. In some embodiments, the third heat exchanger unit is implemented using the same or similar heat exchanger configurations and techniques as discussed above for the second heat exchanger unit 210.

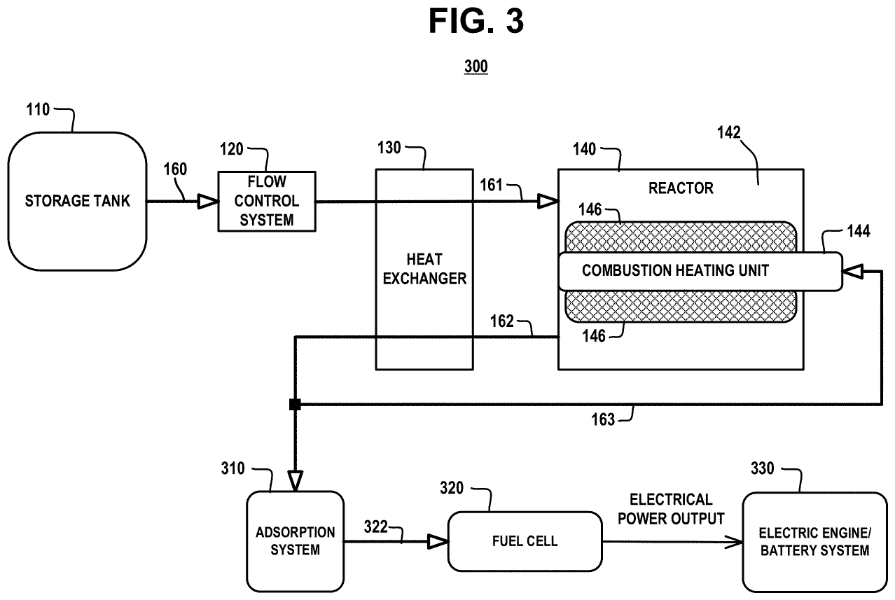

FIG. 3 schematically illustrates a renewable fuel power system 300 for an electric engine vehicle, according to an exemplary embodiment of the disclosure. The renewable fuel power system 300 is similar to the renewable fuel power system 100 of FIG. 1, except that the renewable fuel power system 300 is configured for use with hydrogen fuel cell vehicles in which a hydrogen fuel cell utilizes hydrogen to chemically produce electrical energy to power an electric engine. For such applications, the renewable fuel power system 300 comprises an adsorption system 310, a fuel cell 320, and an electric engine and associated battery system 330. In the exemplary renewable fuel power system 300 of FIG. 3, the ammonia reforming system of the reactor module 140 is configured to deliver hydrogen at a high rate, wherein the fuel output from the reactor module 140 comprises a relatively high concentration of hydrogen with minimal residual ammonia contamination.

The adsorption system 310 is coupled to the output fuel line 162. The adsorption system 310 comprises one or more types of adsorbents which are configured to adsorb residual ammonia and other byproducts of the ammonia reforming process, which may be contained in the fuel that is output from the reactor module 140. In this regard, the adsorption system 310 is configured to refine or purify the hydrogen fuel that is generated by the reactor module 140, before the hydrogen fuel is provided to the fuel cell 320 through a fuel supply line 322. The fuel cell 320 is configured to produce electrical energy using the purified hydrogen fuel that is supplied from the output of the adsorption system 310. In some embodiments, the fuel cell 320 comprises a proton exchange membrane fuel cell (PEMFC) which comprises a proton-exchange membrane that is configured to cause the transformation of chemical energy, which is generated by an electrochemical reaction of the hydrogen fuel and oxygen, into electrical energy that is used to power the electric engine 330 and charge the associated battery. The byproduct of such transformation in the PEMFC is water. In some embodiments, the adsorption system 310 is configured to remove substantially all residual ammonia such that the hydrogen-nitrogen mixture fuel that is supplied to the fuel cell 320 has at least 99.97% purity, with very minimal residual ammonia contamination (e.g., less than 0.1 parts per million). The ammonia can adversely affect the performance of a proton exchange membrane fuel cell, when even a small amount of ammonia is included in the hydrogen supplied to the fuel cell (e.g., 13 ppm of ammonia over long periods of operation can deteriorate the PEMFC).

The renewable fuel power systems 100, 200, and 300 can be implemented in various types of vehicles such as aircraft, automobiles, ships, boats, trains, etc. The specific configurations of the renewable fuel power systems 100, 200, and 300 will vary depending on the given vehicular application, but the general configurations illustrated in FIGS. 1, 2 and 3 for such renewable fuel power systems 100, 200, and 300 are applicable to all types of vehicles. For illustrative purposes, exemplary embodiments of the disclosure will be discussed in the context of implementing the renewable fuel power systems 100, 200, and 300 in aircraft, such as commercial aircraft with jet engines, small single-engine propeller aircraft, aircraft with turboprops, helicopters, etc.

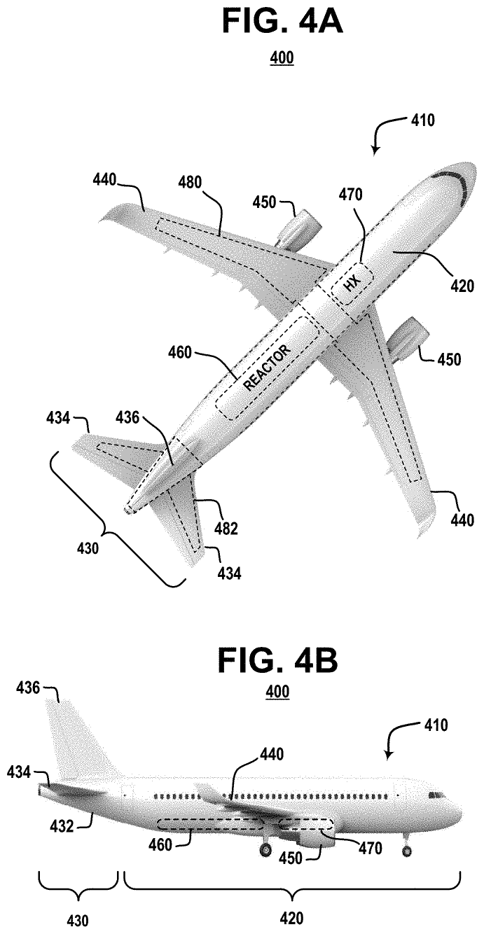

For example, FIGS. 4A and 4B schematically illustrate a configuration for implementing renewable fuel power system 400 for an aircraft which is powered by a combustion engine, according to an exemplary embodiment of the disclosure. More specifically, FIG. 4A is a top view of a jet engine aircraft 410 (e.g., commercial aircraft), while FIG. 4B is side view of the PECK jet engine aircraft 410. The jet engine aircraft 410 comprises a fuselage 420, an empennage 430 (alternatively, tail assembly 430), wings 440, and jet turbine engines 450. The empennage 430 comprises a rear end 432 of the fuselage, horizontal stabilizers 434, and a vertical stabilizer 436. In some embodiments, the jet engines 450 are ammonia combustion engines. In other embodiments, the jet engines 450 are hydrogen combustion engines.

FIGS. 4A and 4B schematically illustrate an exemplary placement of components of the renewable fuel power system 400 including a reactor module 460, a heat exchanger unit 470, and first and second fuel storage tanks 480 and 482. In particular, the first fuel storage tank 480 is disposed in the wings 440, and in a central portion of the fuselage 420. The second fuel storage tank 482 is disposed in the empennage 430, and in particular, in the rear end 432 of the fuselage and in the horizontal stabilizers 434. In some embodiments, the storage tanks 480 and 482 are configured to store liquid ammonia fuel. The reactor module 460 is disposed in lower region of the fuselage 420 primarily behind the wings 440. The heat exchanger unit 470 is disposed in a lower region of the fuselage 420 in proximity to the jet engines 450. In some embodiments, the heat exchanger unit 470 is configured to implement the functions of the heat exchanger unit 130 as shown in FIGS. 1, 2, and 3 (e.g., pre-heat the fuel that is supplied to the reactor module 460). In some embodiments, the heat exchanger unit 470 is further configured to implement the functions of the heat exchanger unit 210 as shown in FIG. 2 (e.g., use combustion exhaust gas generated by the jet turbine engines 450 to provide heat for the reforming process implemented by the reactor module 460).

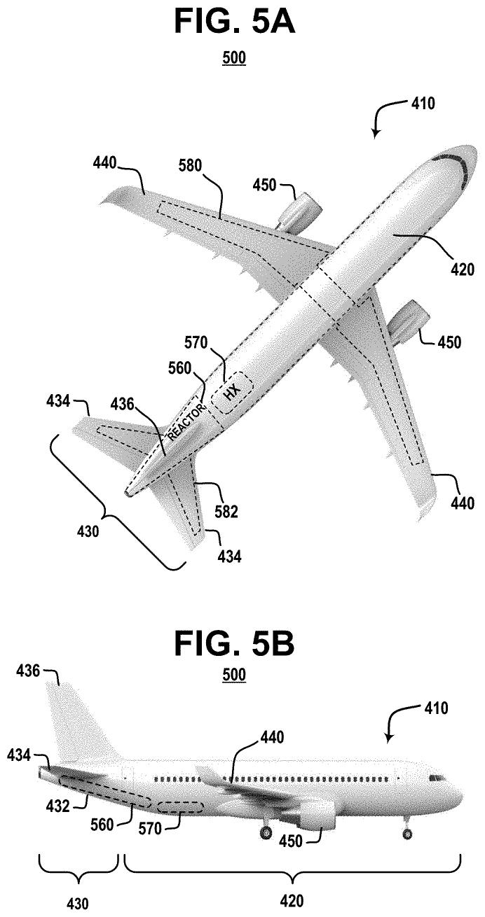

FIGS. 5A and 5B schematically illustrate a configuration for implementing renewable fuel power system 500 for an aircraft which is powered by a combustion engine, according to another exemplary embodiment of the disclosure. In particular, FIGS. 5A and 5B schematically illustrate an exemplary placement of components of the renewable fuel power system 500 for the jet engine aircraft 410, wherein the renewable fuel power system 500 comprises a reactor module 560, a heat exchanger unit 570, and first and second fuel storage tanks 580 and 582. In particular, the first fuel storage tank 580 is disposed in the wings 440, and in a central portion of the fuselage 420. The second fuel storage tank 582 is disposed in the empennage 430, and in particular, in the horizontal stabilizers 434. In some embodiments, the storage tanks 580 and 582 are configured to store liquid ammonia fuel. The reactor module 560 is disposed in the empennage 430 (e.g., in the rear end 432 of the fuselage 420). The heat exchanger unit 570 is disposed in a lower region of the fuselage 420 in proximity to the reactor module 560. In some embodiments, the heat exchanger unit 570 is configured to implement the functions of the heat exchanger unit 130 as shown in FIGS. 1, 2, and 3 (e.g., pre-heat the fuel that is supplied to the reactor module 460).

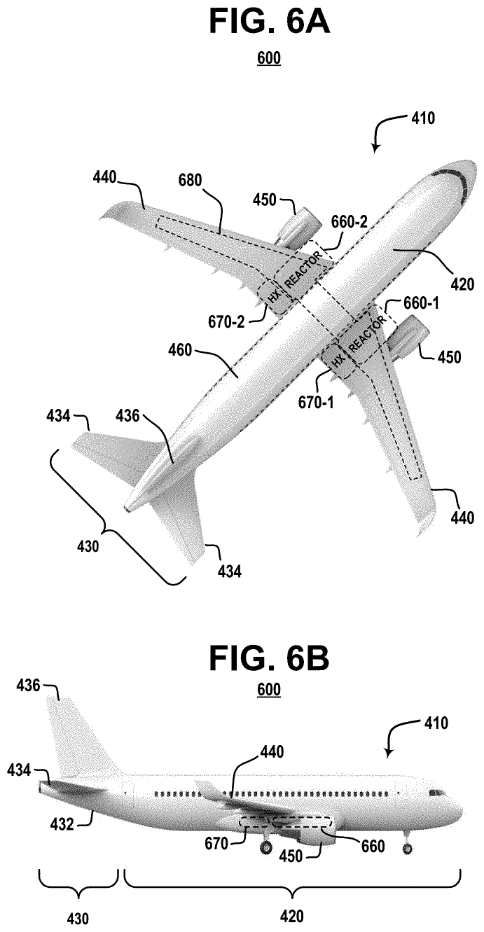

FIGS. 6A and 6B schematically illustrate a configuration for implementing renewable fuel power system 600 for an aircraft which is powered by a combustion engine, according to another exemplary embodiment of the disclosure. In particular, FIGS. 6A and 6B schematically illustrate an exemplary placement of components of the renewable fuel power system 600 for the jet engine aircraft 410, wherein the renewable fuel power system 600 comprises first and second reactor modules 660-1 and 660-2, first and second heat exchanger units 670-1 and 670-2, and fuel storage tanks 680. In particular, first fuel storage tank 680 is disposed in the wings 440, and in a central portion of the fuselage 420. In some embodiments, the storage tank 680 is configured to store liquid ammonia fuel.

In some embodiments, the first and second reactor modules 660-1 and 660-2 are disposed within the wings 440 in proximity to the jet turbine engines 450, and the first and second heat exchanger units 670-1 and 670-2 are disposed within the wings 440 in proximity to the first and second reactor modules 660-1 and 660-2, respectively. In other embodiments, the first and second reactor modules 660-1 and 660-2, and/or the first and second heat exchanger units 670-1 and 670-2 are mounted to the wings 440. In some embodiments, the first and second heat exchanger units 670-1 and 670-2 are configured to implement the functions of the heat exchanger unit 130 as shown in FIGS. 1, 2, and 3 (e.g., pre-heat the fuel that is supplied to the respective first and second reactor modules 660-1 and 660-2). In some embodiments, the first and second heat exchanger units 670-1 and 670-2 are further configured to implement the functions of the heat exchanger unit 210 as shown in FIG. 2 (e.g., use combustion exhaust gas generated by the jet turbine engines 450 to provide heat for the reforming process implemented by the respective first and second reactor modules 660-1 and 660-2). In other embodiments, the first and second reactor modules 660-1 and 660-2 are directly thermally coupled to the jet engines 450 to enable the first and second reactor modules 660-1 and 660-2 to absorb thermal energy generated by the jet engines 450. In some embodiments, the first and second reactor modules 660-1 and 660-2 are integrated with the jet engines.

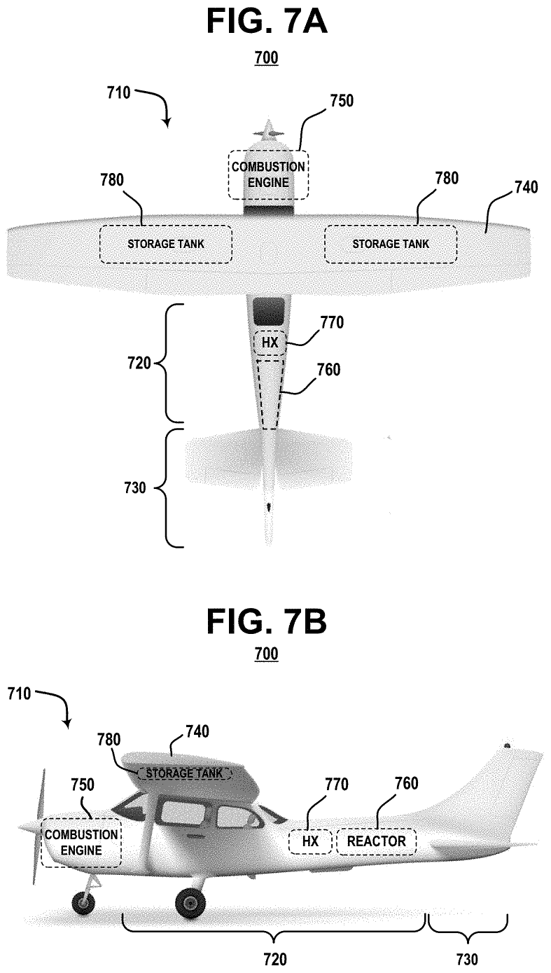

FIGS. 7A and 7B schematically illustrate a configuration for implementing renewable fuel power system 700 for an aircraft which is powered by a combustion engine, according to another exemplary embodiment of the disclosure. More specifically, FIG. 7A is a top view of a single-engine propeller aircraft 710, while FIG. 7B is side view of the single-engine propeller aircraft 710. The single-engine propeller aircraft 710 comprises a fuselage 720, an empennage 730 (alternatively, tail assembly 730), wings 740, and a power plant comprising a combustion engine 750 which operates a propeller. The empennage 730 comprises horizontal stabilizers, and a vertical stabilizer. In some embodiments, the combustion engine 750 is an ammonia combustion engine. In other embodiments, the combustion engine 750 is a hydrogen combustion engine.

FIGS. 7A and 7B schematically illustrate an exemplary placement of components of the renewable fuel power system 700 including a reactor module 760, a heat exchanger unit 770, and fuel storage tanks 780. In particular, the fuel storage tanks 780 are disposed in the wings 740. In some embodiments, the storage tanks 780 are configured to store liquid ammonia fuel. The reactor module 760 is disposed in rear region of the fuselage 720. The heat exchanger unit 770 is disposed in the rear region of the fuselage 720 in proximity to the reactor module 760. In some embodiments, the heat exchanger unit 770 is configured to implement the functions of the heat exchanger unit 130 as shown in FIGS. 1, 2, and 3 (e.g., pre-heat the fuel that is supplied to the reactor module 760). In some embodiments, the heat exchanger unit 770 is further configured to implement the functions of the heat exchanger unit 210 as shown in FIG. 2 (e.g., use combustion exhaust gas generated by the combustion engine 750 to provide heat for the reforming process implemented by the reactor module 760).

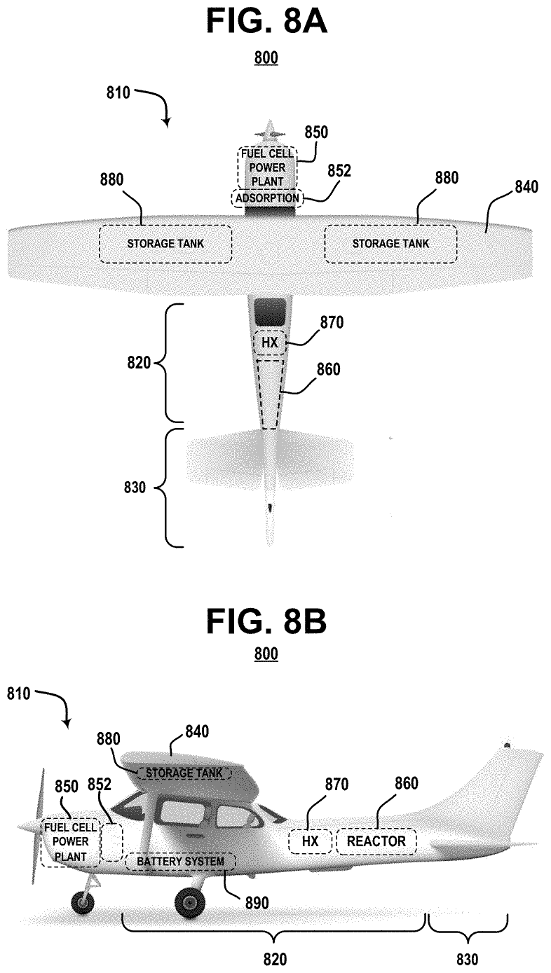

FIGS. 8A and 8B schematically illustrate a configuration for implementing renewable fuel power system 800 for an aircraft which is powered by an electric engine, according to an exemplary embodiment of the disclosure. More specifically, FIG. 8A is a top view of a single-engine propeller aircraft 810, while FIG. 8B is side view of the single-engine propeller aircraft 810. The single-engine propeller aircraft 810 comprises a fuselage 820, an empennage 830 (alternatively, tail assembly 830), wings 840, and a power plant comprising an electric engine which is powered by a hydrogen fuel cell to operate a propeller. The empennage 830 comprises horizontal stabilizers, and a vertical stabilizer. In some embodiments,

FIGS. 8A and 8B schematically illustrate an exemplary placement of components of the renewable fuel power system 800 including a fuel cell power plant 850, an adsorption system 852, a reactor module 860, a heat exchanger unit 870, fuel storage tanks 880, and a battery system 890. In particular, the fuel storage tanks 880 are disposed in the wings 840. In some embodiments, the storage tanks 880 are configured to store liquid ammonia fuel. The reactor module 860 is disposed in rear region of the fuselage 820. The heat exchanger unit 870 is disposed in the rear region of the fuselage 820 in proximity to the reactor module 860. In some embodiments, the heat exchanger unit 870 is configured to implement the functions of the heat exchanger unit 130 as shown in FIGS. 1, 2, and 3 (e.g., pre-heat the fuel that is supplied to the reactor module 860).

The adsorption system 852 is configured to implement the functions of the adsorption system 310 as shown in FIG. 3 such as adsorbing residual ammonia and other byproducts of the ammonia reforming process, which may be contained in the hydrogen fuel that is output from the reactor module 860 before supplying the hydrogen fuel to the power plant fuel cell 850. The power plant fuel cell 850 is configured to produce electrical energy using the purified hydrogen fuel that is supplied from the output of the adsorption system 852. In some embodiments, the fuel cell 850 comprises a PEMFC, which generates electrical energy that is used to power the electric engine and charge the associated battery system 890. In some embodiments, as shown in FIG. 8B, the battery system 890 is disposed in lower front region of the fuselage 820 near the power plant.

It is to be understood that the exemplary reactor module 140 is generally shown in FIGS. 1, 2, and 3 for ease of illustration and discussion. It is to be understood, however, that the actual configuration of a reactor module for reforming ammonia (to produce hydrogen) will vary with regard to, e.g., the physical size and layout of the reactor, the types of catalysts used, the operating temperatures, and pressures, etc., depending on the amount of power needed to operate a given type of vehicle, and the type of engine (combustion or electric) of the vehicle, etc. Various techniques for implementing reactor modules and associated catalysts and processes for ammonia reforming are discussed in further detail in the disclosures of the above-incorporated Provisional Applications 63/188,593 and 63/209,530.

In some embodiments, as disclosed in the Provisional Applications 63/188,593 and 63/209,530, the reactor module 140 is implemented using one or more catalyst beds with catalyst materials that are optimized for reforming ammonia. In some embodiments, a catalyst bed comprises a tube or channel that contains ammonia decomposition catalyst particles or pellets, wherein ammonia flows through the tube or channel and interacts with the catalyst material across the length of the tube/channel to thereby reform the ammonia to produce hydrogen. In some embodiments, as schematically illustrated in FIGS. 1, 2 and 3, the catalyst 146 comprises catalyst particles that are in thermal contact with the outer surface of the combustion heater unit 144. In some embodiments, the catalyst 146 comprises a metal catalyst foam (e.g., a nickel chromium aluminum (NiCrAl) foam) that is formed on the outer surface of metallic tubing of the combustion heating unit 144. While only one catalyst bed may be schematically depicted in the reactor module 140 of FIGS. 1, 2, and 3 for ease of illustration, the reactor module 140 may comprise multiple catalyst beds that are configured to operate in parallel in a controlled manner to, e.g., adjustably control an amount of hydrogen that is extracted per unit weight or volume of ammonia, that is input to the reactor module 140.

Provisional Application 63/209,530 discloses various methods to fabricate catalyst materials that are optimized for processing ammonia to generate hydrogen. The optimized catalyst materials are designed to exhibit an optimal morphology and/or physical or chemical property for active metal nanoparticles that are utilized to facilitate ammonia decomposition. For example, the physical or chemical property corresponds to a surface chemistry or property of the one or more active metal nanoparticles. Further, the optimized catalyst materials are designed to exhibit an optimal level of dispersion of the active metal nanoparticles. The optimized catalyst materials are designed to maintain favorable physical and chemical properties under harsh reaction conditions, and to exhibit high thermal stability and optimal heat transfer rates to enable efficient endothermic ammonia decomposition reactions. The catalyst fabrication methods as disclosed in Provisional Application 63/209,530 are configured to produce catalyst materials that can decompose ammonia efficiently at lower reaction temperatures, and can extract a greater amount of hydrogen per unit weight or volume of ammonia while using a lower concentration of active metals (e.g., lower ruthenium content).

In some embodiments, the catalyst 146 shown in the reactor module 140 (in FIGS. 1, 2, and 3) comprises a metal material, a promoter material, and a support material. In some embodiments, the metal material comprises ruthenium, nickel, rhodium, iridium, cobalt, iron, platinum, chromium, palladium, and/or copper. In some embodiments, the promoter material comprises sodium, potassium, rubidium, and/or cesium. In some embodiments, the support material comprises Al₂O₃, MgO, CeO₂, SiO₂, or TiO₂. In some embodiments, a metal foam catalyst comprises nickel, iron, chromium, and/or aluminum. In some cases, the metal foam catalyst comprises one or more alloys comprising nickel, iron, chromium, and/or aluminum.

In some embodiments, the metal foam catalyst comprises a catalytic coating of one or more powder or pellet catalysts. In some embodiments, the catalytic coating comprises a metal material, a promoter material, and/or a support material. In some embodiments, the metal material comprises, e.g., ruthenium, nickel, rhodium, iridium, cobalt, iron, platinum, chromium, palladium, and/or copper, and the promoter material comprises, e.g., sodium, potassium, rubidium, and/or cesium. In some embodiments, the support material may comprise, for example, Al₂O₃, MgO, CeO₂, SiO₂, TiO₂, hexagonal boron nitride, one or more boron nitride nanotubes, and/or one or more carbon nanotubes. In some embodiments, the catalytic coating may comprise one or more ruthenium-based precursors. The one or more ruthenium-based precursors may comprise, for example, RuCl₃ or Ru₃(CO)₁₂. In some embodiments, the metal foam catalyst is processed using one or more etching, alloying, leaching, or acidic treatments to enhance a surface area of the metal foam catalyst. In some embodiments, the metal foam catalyst is heat treated. In some embodiments, the metal foam catalyst is coated with thin layers of materials using a physical vapor deposition (PVD) treatment and/or a chemical vapor deposition (CVD).

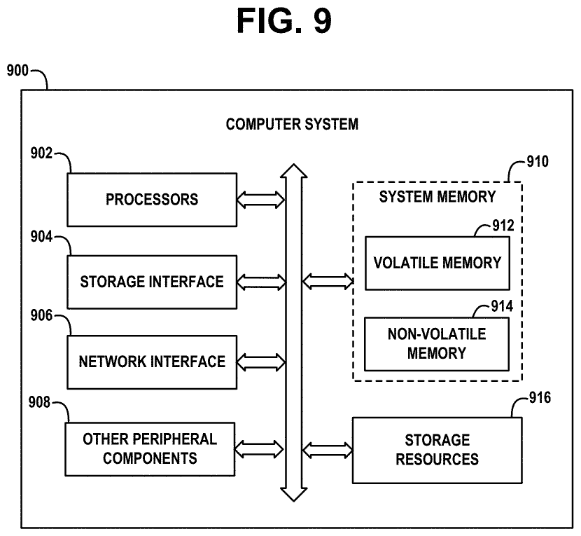

FIG. 9 schematically illustrates an exemplary architecture of a computer system 900 which is configured to monitor and control a renewable fuel power system, according to an exemplary embodiment of the disclosure. The computer system 900 comprises processors 902, storage interface circuitry 904, network interface circuitry 906, peripheral components 908, system memory 910, and storage resources 916. The system memory 910 comprises volatile memory 912 and non-volatile memory 914. The processors 902 comprise one or more types of hardware processors that are configured to process program instructions and data to execute a native operating system (OS) and applications that run on the computer system 900.

For example, the processors 902 may comprise one or more CPUs, microprocessors, microcontrollers, application specific integrated circuits (ASIC s), field programmable gate arrays (FPGAs), and other types of processors, as well as portions or combinations of such processors. The term “processor” as used herein is intended to be broadly construed so as to include any type of processor that performs processing functions based on software, hardware, firmware, etc. For example, a “processor” is broadly construed so as to encompass all types of hardware processors including, for example, (i) general purpose processors (e.g., multi-core processors), and (ii) workload-optimized processors, which comprise any possible combination of multiple “throughput cores” and/or multiple hardware-based accelerators. Examples of workload-optimized processors include, for example, graphics processing units (GPUs), digital signal processors (DSPs), system-on-chip (SoC), artificial intelligence (AI) accelerators, and other types of specialized processors or coprocessors that are configured to execute one or more fixed functions.

The storage interface circuitry 904 enables the processors 902 to interface and communicate with the system memory 910, the storage resources 916, and other local storage and off-infrastructure storage media, using one or more standard communication and/or storage control protocols to read data from or write data to volatile and non-volatile memory/storage devices. Such protocols include, but are not limited to, NVMe, PCIe, PATA, SATA, SAS, Fibre Channel, etc. The network interface circuitry 906 enables the computer system 900 to interface and communicate with a network and other system components. The network interface circuitry 906 comprises network controllers such as network cards and resources (e.g., network interface controllers (NICs) (e.g., SmartNICs, RDMA-enabled NICs), Host Bus Adapter (HBA) cards, Host Channel Adapter (HCA) cards, I/O adaptors, converged Ethernet adaptors, etc.) to support communication protocols and interfaces including, but not limited to, PCIe, DMA and RDMA data transfer protocols, etc. The computer system 900 can be operatively coupled to a communications network such as the Internet, an internet and/or extranet, or an intranet and/or extranet that is in communication with the Internet. The network in some cases is a telecommunication and/or data network. The network can include one or more computer servers, which can enable distributed computing, such as cloud computing.

The system memory 910 comprises various types of memory such as volatile random-access memory (RAM), non-volatile RAM (NVRAM), or other types of memory, in any combination. The volatile memory 912 may be a dynamic random-access memory (DRAM) (e.g., DRAM DIMM (Dual In-line Memory Module), or other forms of volatile RAM. The non-volatile memory 914 may comprise one or more of NAND Flash storage devices, solid-state drive (SSD) devices, or other types of next generation non-volatile memory (NGNVM) devices. The term “memory” or “system memory” as used herein refers to volatile and/or non-volatile memory which is utilized to store application program instructions that are read and processed by the processors 902 to execute a native OS and one or more applications or processes hosted by the computer system 900, and to temporarily store data that is utilized and/or generated by the native OS and application programs and processes running on the computer system 900. The storage resources 916 can include one or more hard disk drives (HDDs), SSD devices, etc.

The computer system 900 is programmed or otherwise configured to monitor and control various functions and operations of the exemplary renewable fuel power systems as described herein. For example, the computer system 900 may be configured to (i) control a flow of a source material (e.g., ammonia) from a storage tank to a reactor module, (ii) control an operation of a heating unit of the reactor module (iii) control a flow of fuel (e.g., hydrogen fuel, hydrogen-ammonia fuel mixture, etc.) which is output from the reactor module and supplied to, e.g., hydrogen fuel cell, or a combustion engine), (iv) control a reforming process (e.g., ammonia reforming process) performed by the reactor module to, e.g., adjust a rate of converting ammonia to hydrogen, etc. The computer system 900 may control a flow of the source material to the reactor module and/or a flow of the hydrogen from the reactor module to the one or more fuel cells by modulating one or more flow control mechanisms (e.g., one or more valves). The computer system 900 may control an operation of the combustion heating unit by controlling a flow of combustion fuel that is applied to the combustion heating unit, or otherwise activating/deactivating the operation of the combustion heating unit.

In some embodiments, the monitoring and control processes are implemented by the computer system 900 executing software, wherein program code is loaded into the system memory 910 (e.g., volatile memory 912), and executed by the processors 902 to perform the control functions as described herein. In this regard, the system memory 910, the storage resources 916, and other memory or storage resources as described herein, which have program code and data tangibly embodied thereon, are examples of what is more generally referred to herein as “processor-readable storage media” that store executable program code of one or more software programs. Articles of manufacture comprising such processor-readable storage media are considered embodiments of the disclosure. An article of manufacture may comprise, for example, a storage device such as a storage disk, a storage array or an integrated circuit containing memory. The term “article of manufacture” as used herein should be understood to exclude transitory, propagating signals.

In some embodiments, the peripheral components 908 include hardware interfaces (and drivers) for communicating with various sensors devices that are disposed in various modules and components of a renewable fuel power system. The computer system 900 can control the operation of various modules and components of the renewable fuel power system by receiving and processing sensors readings (e.g., temperature measurements, flow rates, etc.) from various sensor devices of the modules/components of the renewable fuel power system, and generating control signals that are sent to the modules/components of the renewable fuel power system to control the operation of the renewable fuel power system.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a storage tank configured to store ammonia in liquid form;
a reactor module in fluid communication with the storage tank, wherein the reactor module is configured to extract hydrogen from the ammonia, and output fuel which comprises the extracted hydrogen;
a first heat exchanger unit configured to heat the ammonia which flows from the storage tank to an input of the reactor module, using heat which is extracted from the fuel that is output from the reactor module; and
a combustion engine coupled to an output of the reactor module, wherein the combustion engine is configured to combust the fuel provided by the reactor module, to thereby produce mechanical power.

2. The system of claim 1, wherein:
the combustion engine comprises an ammonia combustion engine; and
the fuel output from the reactor module comprises mixture of ammonia and the extracted hydrogen.

3. The system of claim 1, wherein:
the combustion engine comprises a hydrogen combustion engine; and
the fuel output from the reactor module primarily comprises the extracted hydrogen.

4. The system of claim 1, further comprising a second heat exchanger configured to heat at least one of the reactor module and the storage tank using heated combustion gas output from the combustion engine.

5. The system of claim 1, wherein the reactor module is thermally coupled to the combustion engine using a structural thermal interface which is configured to transfer heat generated by the combustion engine to the reactor module to thereby heat the reactor module.

6. The system of claim 1, wherein:
the reactor module comprises a catalyst, and a heating unit configured to heat the catalyst;
the catalyst is configured to extract hydrogen from the ammonia when the catalyst is heated by the heating unit; and
the heating unit comprises a combustion heating unit which is configured to receive a portion of the fuel output from the reactor module, and combust the received fuel to generate the heat for heating the catalyst.

7. An aircraft, comprising:
a storage tank configured to store ammonia in liquid form;
a reactor module in fluid communication with the storage tank, wherein the reactor module is configured to extract hydrogen from the ammonia, and output fuel which comprises the extracted hydrogen;
a first heat exchanger unit configured to heat the ammonia which flows from the storage tank to an input of the reactor module, using heat which is extracted from the fuel that is output from the reactor module; and
a combustion engine coupled to an output of the reactor module, wherein the combustion engine is configured to combust the fuel provided by the reactor module, to thereby produce mechanical power.

8. The aircraft of claim 7, wherein the combustion engine comprises a jet turbine engine.

9. The aircraft of claim 7, wherein the reactor module and first heat exchanger are disposed in a fuselage of the aircraft.

10. The aircraft of claim 7, wherein the reactor module and the first heat exchanger are disposed in or on a wing of the aircraft.

11. The aircraft of claim 7, wherein the reactor module is disposed in an empennage of the aircraft.

12. The aircraft of claim 7, wherein the storage tank comprises:
a first storage tank disposed in an empennage of the aircraft; and
a second storage tank disposed in a wing of the aircraft.

13. The aircraft of claim 7, wherein the reactor module is thermally coupled to the combustion engine.

14. The aircraft of claim 7, wherein:
the combustion engine comprises an ammonia combustion engine; and
the fuel output from the reactor module comprises mixture of ammonia and the extracted hydrogen.

15. The aircraft of claim 7, wherein:
the combustion engine comprises a hydrogen combustion engine; and
the fuel output from the reactor module primarily comprises the extracted hydrogen.

16. The aircraft of claim 7, further comprising a second heat exchanger configured to heat at least one of the reactor module and the storage tank using heated combustion gas output from the combustion engine.

17. The aircraft of claim 7, wherein:
the reactor module comprises a catalyst, and a heating unit configured to heat the catalyst;
the catalyst is configured to extract hydrogen from the ammonia when the catalyst is heated by the heating unit; and
the heating unit comprises a combustion heating unit which is configured to receive a portion of the fuel output from the reactor module, and combust the received fuel to generate the heat for heating the catalyst.

18. An aircraft, comprising:
a storage tank configured to store ammonia in liquid form;
a reactor module in fluid communication with the storage tank, wherein the reactor module is configured to extract hydrogen from the ammonia, and output fuel which comprises the extracted hydrogen;
a first heat exchanger unit configured to heat the ammonia which flows from the storage tank to an input of the reactor module, using heat which is extracted from the fuel that is output from the reactor module;
a fuel cell coupled to an output of the reactor module, wherein the fuel cell is configured to convert the fuel provided by the reactor module into electrical power; and
an electric engine coupled to an output of the fuel cell, wherein the electric engine is configured to convert the electrical power into mechanical power.

19. The aircraft of claim 18, further comprising:
an adsorption unit configured to process the fuel output from the reactor module and output pure hydrogen fuel to the fuel cell; and
a battery system coupled to an output of the fuel cell.

20. The aircraft of claim 18, wherein:
the reactor module comprises a catalyst, and a heating unit configured to heat the catalyst;
the catalyst is configured to extract hydrogen from the ammonia when the catalyst is heated by the heating unit; and
the heating unit comprises a combustion heating unit which is configured to receive a portion of the fuel output from the reactor module, and combust the received fuel to generate the heat for heating the catalyst.
